(19) United States
(12) Patent Application Publication
(10) Pub. No.: US 2020/0115944 A1
(43) Pub. Date: Apr. 16, 2020

(54) APPARATUS TO MINIMISE INJURY CAUSED BY AN EXTREMITY TRAPPED BY A CLOSING HINGED DOOR

(71) Applicant: Andrew WELCH, Sevenoaks (GB)

(72) Inventor: Andrew WELCH, Sevenoaks (GB)

(21) Appl. No.: 16/616,450

(22) PCT Filed: May 18, 2018
(86) PCT No.: PCT/GB18/51352

§ 371 Date: Nov. 23, 2019

(30) Foreign Application Priority Data
May 23, 2017 (EP) 17275074.7

(51) Int. Cl. E05F 5/04; E05C 17/00

(52) U.S. Cl. CPC E05F 5/04; E05Y 2900/132; E05F 2005/046; E05C 17/025

(57) ABSTRACT

An apparatus is provided having a foam cushion (9) attached to an elongate elastic member (8). Adhesive pads (10) are attached one to each end of the elastic member (8). A “U” shaped resiliently deformable handle is attached to the uppermost and lowest cushion (9) and adapted to project through the hinge gap formed between the hinge stile (6) and the door jamb (7) when the door is swung open. The apparatus can be secured to the hinge stile (6) of a hinge mounted door leaf (3) by means of the adhesive pads (10) and with the elastic member (8) under sufficient tension to keep the cushions resting against the hinge stile and the handle projecting through the hinge gap. If an attempt is made to close the door without displacing the cushions 9 from the hinge gap the cushions prevent full closure. To fully close the door the handle is pulled from the hinge side of the door, until the cushions (9) are displaced through the hinge gap and the door can then be closed. The cushions are too wide to pass through the reduced hinge gap when the door is closed. When the door is opened the spring force of the elastic member causes the cushions (9) to pull back through the widening hinge gap.

### TECHNICAL FIELD

A hinge mounted door consists of a leaf mounted to a frame by means of one or more hinges. More particularly the leaf has a hinge stile to which one leaf of a hinge is attached while the second leaf of the hinge is secured to a hinge jamb forming an upright member of the frame. The leaf closes against a stop member of the frame.

The action of doors is peculiarly fascinating to infants who are vulnerable to trapping inquisitive fingers in the hinge space formed between an open door leaf and the hinge jamb. This will cause severe pain and is known to cause permanent injury as the edge of the door stile and door jamb act like a guillotine and may sever the tip of a finger.

The apparatus of the present invention seeks to provide a technical means to alleviate this hazard, while continuing to allow the door to be easily, deliberately closed. Doors are expensive to repair or replace and are commonly a design feature of a building. To succeed the apparatus must avoid marring the appearance of the door or causing permanent damage. In many applications the installation must be temporary, so the apparatus must be capable of permanent removal when use is no longer required. Furthermore the apparatus must be inexpensive to manufacture and retail and require minimal skill to install, else the expense will preclude the installation of the apparatus on every door presenting a threat.

### PRIOR ART

Numerous prior art apparatus have been proposed to alleviate the described problem, some of which are exemplified in the documents listed below: WO2012113139, US20110154610, GB20084573, US20050161954, US20060026793, CN1724843, US20040107647, U.S. Pat. Nos. 5,680,675, 5,509,235.

The prior art apparatus referenced above act by introducing a “bumper” into the hinge space between the hinge stile and the hinge jamb to prevent the door closing fully. For example the most relevant known prior art is WO2012113139. WO2012113139 proposes a cylindrical bumper attached to an anchor by means of an elastic leash. The apparatus is installed by dropping the apparatus into a hinge gap formed between the hinge stile and the hinge jamb on a hinge side of the door so that, with the elastic leash relaxed, the bumper sits in the hinge space between the hinge stile and hinge jamb and the anchor rests against the door on the hinge side. The bumper thus prevents the door closing. To allow the door to close the bumper must be grasped in the hinge gap and drawn away from the gap until the door is swung closed. The bumper can then be released. This suffers the disadvantage that the door can only be closed from the stop side (opposite the hinge side).

US20110154610 proposes a bumper supported by a housing. The bumper is attached to the housing by a string cradle and an actuating string. The string cradle provides a pivot or swing which suspends the bumper against the door jamb and allows it to rotate towards the door stop when the actuating string is pulled. In this case the actuating string is pulled from the hinge side of the door. This solution fails where a frame stop is fitted to the door frame (as is nearly always the case) since the stop will foul the bumper and prevent it from exiting the hinge space.

The remaining documents have been referenced as background art although they are of less relevance than the two described above.

### STATEMENT OF INVENTION

Apparatus to minimise injury caused by an extremity trapped between a closing door having a hinge stile and mounted by means of a hinge acting between the hinge stile and a hinge jamb member of a door frame adjacent a door stop comprising:

a flexible member capable of attachment to the hinge jamb or hinge stile, said flexible member supporting a bumper, whereby the bumper is urged to a first condition settled into a hinge space between the hinge stile and the hinge jamb when the door is swung on its hinges to an at least partially open condition, said bumper acting to resist the door closing fully, and

a handle arranged to be manually operable to move the bumper from the first condition to a second condition when the door is opened, where the bumper is displaced from the hinge space to facilitate full closure of the door;

said handle being fabricated to be resiliently deformable in a first horizontal direction and substantially rigid in a second direction corresponding to a vertical direction when installed on a hinge stile or hinge jamb, whereby the handle can project through a hinge gap to be accessed from the hinge side of the door, said bumper being resiliently deformable to facilitate drawing the bumper through the hinge gap by means of the handle.

Further according to the present invention there is provided an assembly of an apparatus to minimise injury caused by an extremity trapped between a closing door having a hinge stile and mounted by means of a hinge acting between the hinge stile and a hinge jamb member of a door frame adjacent a door stop and a door having a leaf including a hinge stile and a frame including a door jamb comprising: a flexible member attached to one of the door jamb or hinge stile, said flexible member supporting a bumper, whereby the bumper is urged to a first condition settled into a hinge space between the hinge stile and the hinge jamb when the door is swung on its hinges to an at least partially open condition, said bumper acting to resist the door closing fully, and

a handle arranged to be manually operable to move the bumper from the first condition to a second condition when the door is opened, whereby the bumper is displaced from the hinge space through a hinge gap to facilitate full closure of the door;

said handle being fabricated to be resiliently deformable in a first horizontal direction and substantially rigid in a second direction corresponding to a vertical direction when installed on a hinge stile or hinge jamb, whereby the handle projects through the hinge gap to be accessed from the hinge side of the door, said bumper being resiliently deformable to facilitate drawing the bumper through the hinge gap by means of the handle.

The bumper may be urged into the hinge gap solely by its weight. However it is preferable that the flexible member is elastic and may be attached to the hinge stile or the door jamb above and below the bumper, under tension, whereby the flexible member provides a spring force, when displaced to the second condition, to urge the bumper to the first condition. The flexible member may be attached by fastening means such as; pins, screws or similar known fastening means but is preferably attached by at least two adhesive pads to the hinge stile. A spacer may be provided to act between the fastening means to ensure that there is sufficient tension applied to the elastic flexible member.

The bumper is preferably provided by one or more resiliently deformable foam cushions. The width of the bumper may be such that it spans more than the whole thickness of the door stile so that where the door frame includes a door stop the bumper engages the door stop when in the first condition. Standard internal door sizes are 35 mm thick and 40 mm thick. Accordingly the bumper should be greater than 25 mm thick and may be greater than 35 mm thick and preferably greater than 40 mm thick. In addition to a resilient bumper a rigid bumper may also be provided of less width than the resilient bumper. The resilient bumper will slow a closing door and prevent damage to the door stile or door jamb from a door closing forcefully. The rigid bumper will ensure that the door cannot be fully closed with the bumper in the first condition. Preferably a plurality of bumpers are provided disposed vertically along the flexible member. The bumpers are preferably spaced from each other by a gap. This facilitates the bumpers returning to the rest position in the hinge space by comparison with a single bumper covering a similar height to the plurality of bumpers.

The handle may be attached to one or more of the bumpers or to the flexible member. The handle will preferably be attached either directly or indirectly to the flexible member at two vertically spaced locations. Where the flexible member is an elastic member secured above and below the bumper this enables the handle to be effectively supported to project horizontally through the hinge gap when installed. Preferably the vertically spaced locations span all of the bumpers so that all the bumpers are equally displaced by manual movement of the handle.

To close the door from the frame stop side the user can reach into the hinge gap to grasp the bumper or bumpers and pull the bumpers out of the hinge gap before closing the door.

In addition to the handle projecting through the hinge gap, a second handle may be provided to project towards the stop side in order to facilitate closing the door from the stop side.

### BRIEF DESCRIPTION OF DRAWINGS

Embodiments of an apparatus to minimise injury caused by an extremity trapped between a closing door having a hinge stile and mounted by means of a hinge acting between the hinge stile and a hinge jamb member of a door frame adjacent a door stop, and an assembly of such apparatus and a door, will now be described, by way of example only, with reference to the accompanying figures, in which:

FIG. 1.1 is a NW isometric view of the assembly including the first embodiment of the invention;

FIG. 1.2 is a SE isometric view of the assembly of FIG. 1.1 with the door open and the apparatus in the first condition;

FIG. 1.3 is an enlarged detail isometric view of the region enveloped by the dashed line in FIG. 1.1;

FIG. 1.4 is an enlarged detail isometric view of the region enveloped by the dashed line in FIG. 1.2;

FIG. 1.5 is a left front elevation of the apparatus of the first embodiment from FIG. 1.1;

FIG. 1.6 is a SE isometric view of the assembly of FIG. 1.1 with the door closed from the hinge side and the apparatus in the second condition;

FIG. 1.7 is an enlarged detail on the dashed line envelope of FIG. 1.6;

FIG. 1.8 is a NW isometric view of the assembly including the first embodiment with the door closed from the stop side;

FIG. 1.9 is an enlarged view on the dashed envelope line of FIG. 1.8 showing hidden features;

FIG. 1.10 is an enlarged, fragmental, plan, sectional view on the section line 1.10 in FIG. 1.5;

FIG. 2.1 is a NW isometric view of the assembly including a second embodiment of the invention;

FIG. 2.2 is an enlarged view on the dashed envelope line of FIG. 2.1:

FIG. 2.3 is a front elevation of the apparatus of the second embodiment from FIG. 2.2;

FIG. 2.4 is a SE isometric view of the apparatus of FIG. 2.3.

### DETAILED DESCRIPTION OF DRAWINGS

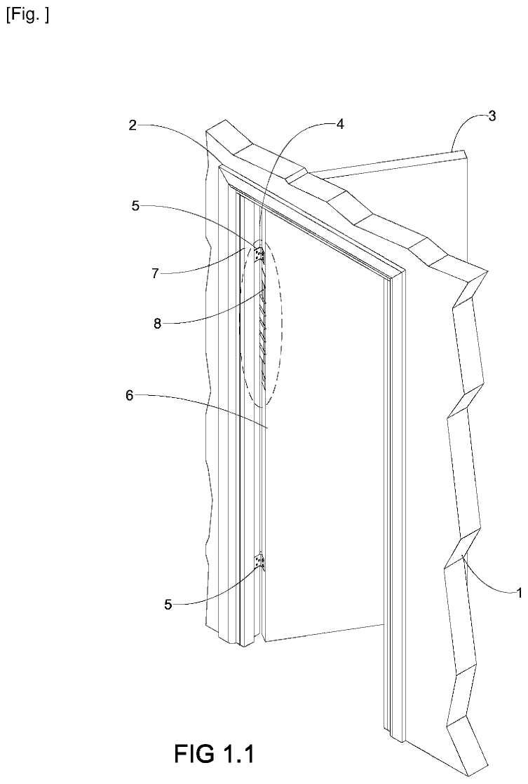

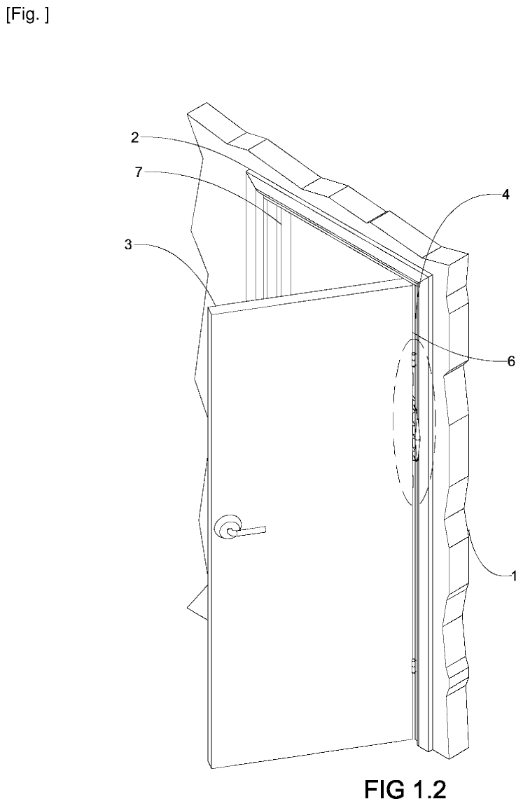

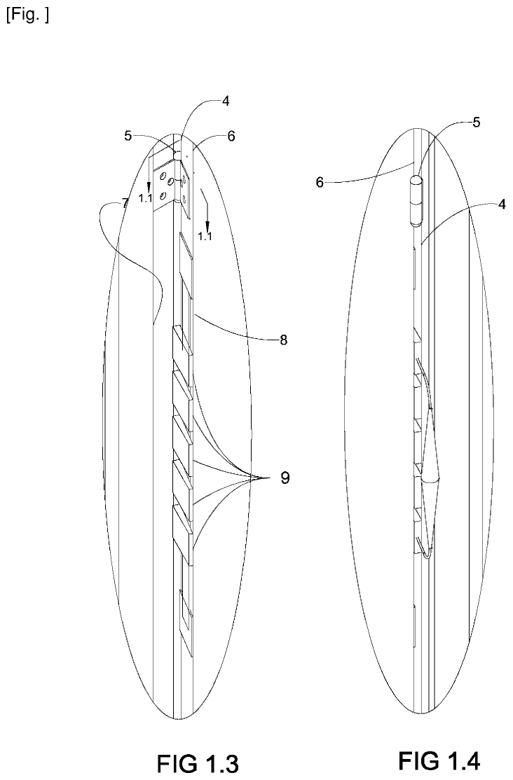

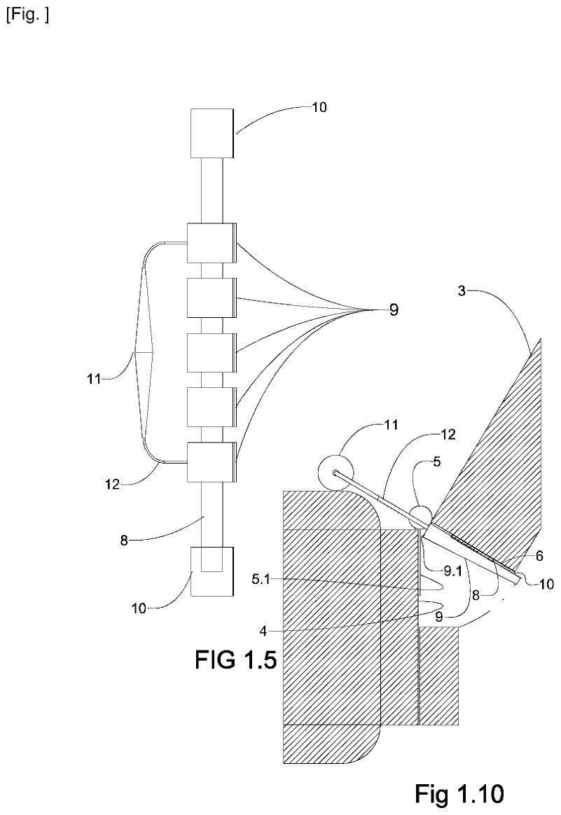

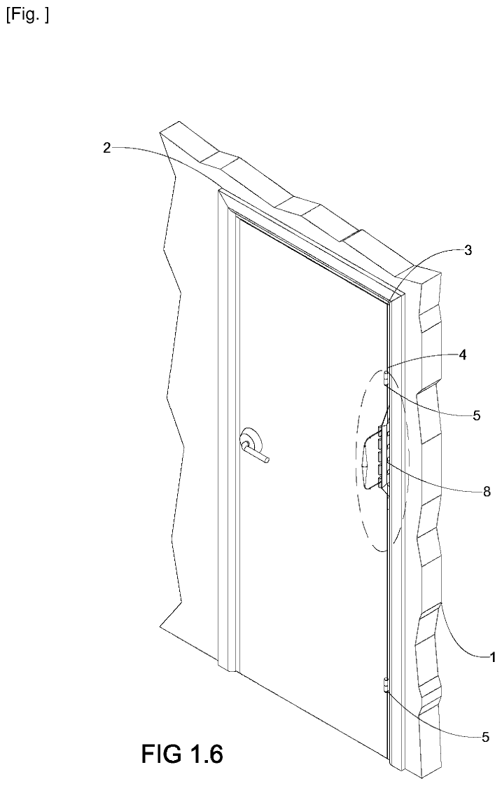

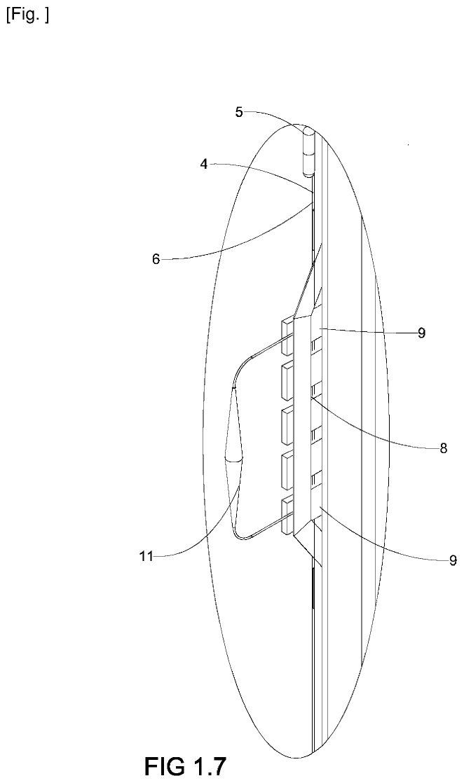

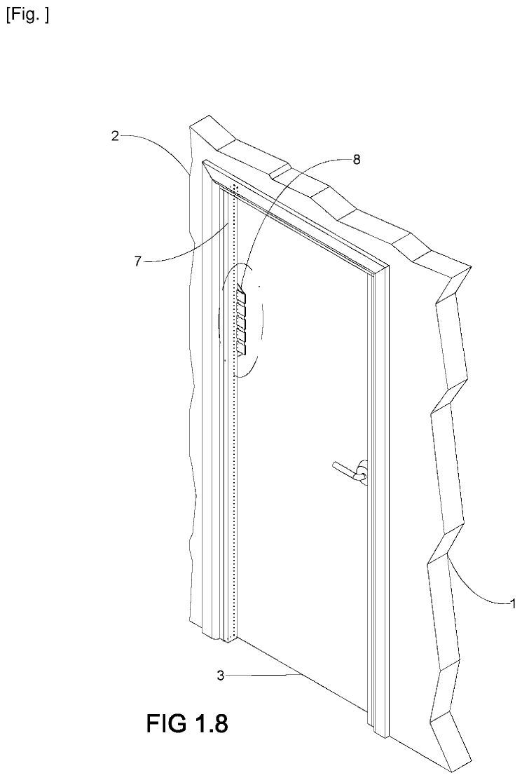

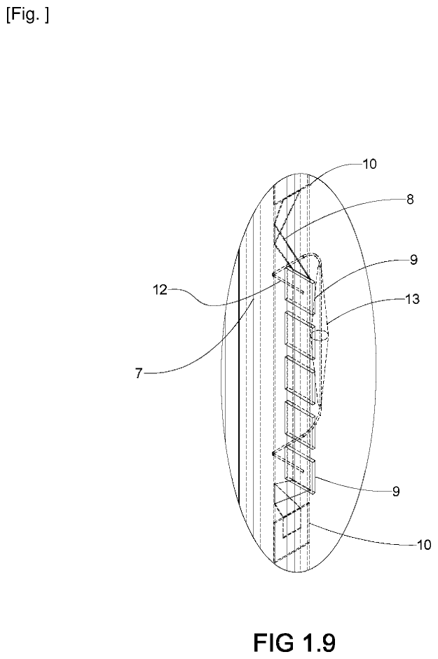

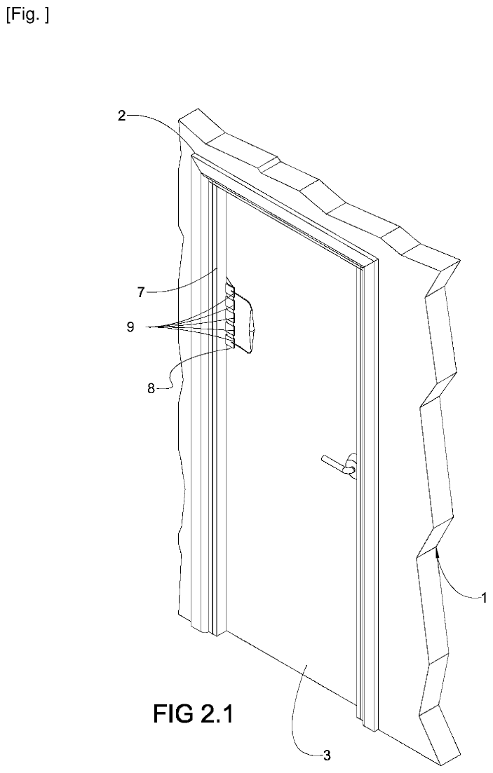

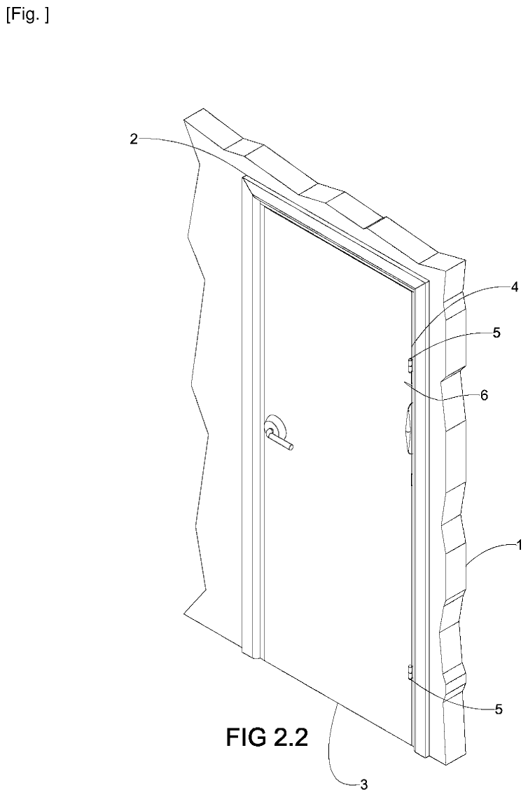

Referring to the FIGS. 1.1 and 1.2 show a wall 1, including a door comprising a door frame, generally 2, and a door leaf 3. The door frame 2 has a hinge jamb 4 to which a jamb leaf 5.1 of each of a pair of hinges 5 are secured. The door leaf 3 includes a hinge stile 6 to which a stile leaf 5.2 of each hinge 5 is secured. The door frame 2 also includes a door stop 7.

The apparatus to minimise injury caused by an extremity trapped between a closing door and frame has a flexible member provided by an elastic strip 8. Five bumpers are provided by resiliently deformable pads 9. Each pad 9 is secured to the strip 8 and separated by a gap to be spaced at regular intervals between the ends of the strip 8. Each end of the strip is secured to an adhesive pads 10 whereby the ends of the strip can are secured to the hinge stile 6 leaving the intermediate portion of the strip between the ends free to move laterally with respect to the ends and the hinge stile. Sufficient space is left between each of the uppermost and lowermost pads 9, and the adhesive pads 10, to allow all the pads 9 to be displaced laterally sufficiently to be removed from the hinge gap between the hinge stile and the hinge jamb.

A handle 11 is provided by a “U” shaped resiliently deformable wire 12 secured at one end to the uppermost pad 9 and at the other end to the lowermost pad 9. The wire 12 is sufficiently stiff to support the weight of the handle under its own weight but the thickness of the wire in the horizontal direction is less than the hinge gap remaining when the door is closed. This can be achieved by a combination of materials selection and by asymmetric geometry. The handle 11 includes a grip part 13 to facilitate manually grasping the handle and pulling in use.

The apparatus is secured to the door by means of the pads 10 as shown in FIGS. 1.1 and 1.2 so that the elastic strip 8 is under some tension. This draws the pads 9 into the hinge gap and or against the stop 7 so that the pads 9 prevent the door leaf from closing against the stop 7 or the hinge jamb 4. To close the door the handle 11 is pulled laterally away from the hinge gap from the hinge side of the door. The pads 9 deform sufficiently to allow them to pass through the hinge gap. The door can then be closed from the hinge side as shown in FIGS. 1.6 and 1.7.

The pads 9 may be formed from closed cell foam. Each pad may be generally rectangular with a cross section, in plan view, forming a wedge as shown in FIG. 1.6. The base end 9.1 of the wedge faces towards the handle 11, while the top end of the wedge 9.2 is remote from the handle 11. Thus in use the pad 9 is readily drawn back into the hinge space under the action of the elastic strip 8. Also the greatest width at the base 9.1 is engaged first by a closing door.

To close the door from the stop side the user reaches into the hinge gap to grasp the pads or elastic strip and draws the pads out of the hinge gap before closing the door. The asymmetric flexibility of the handle allows the handle wire 12 to deform in the space between the hinge jamb and the stop to the condition shown in FIGS. 1.8 and 1.9.

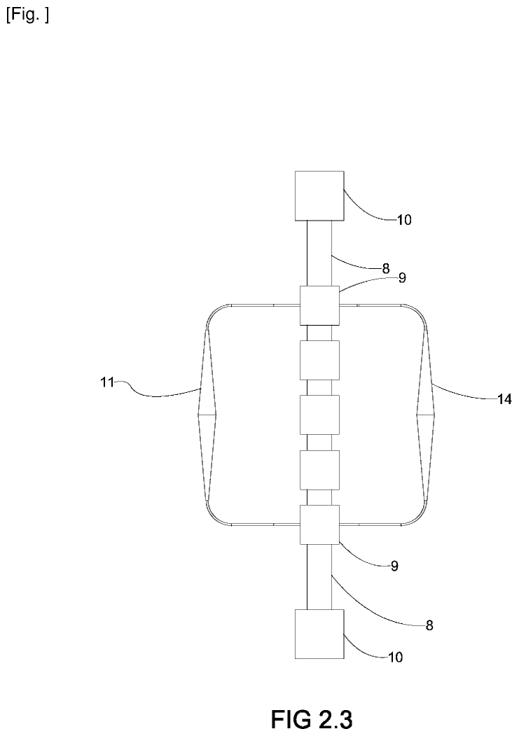

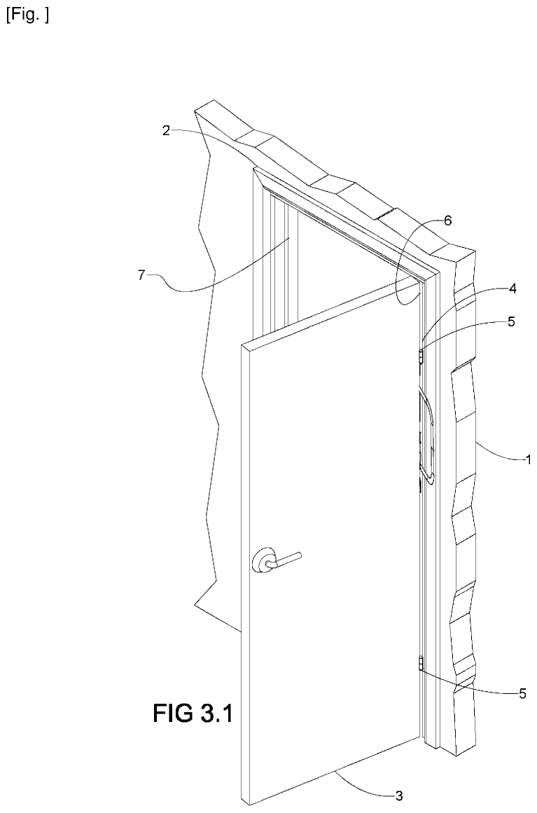

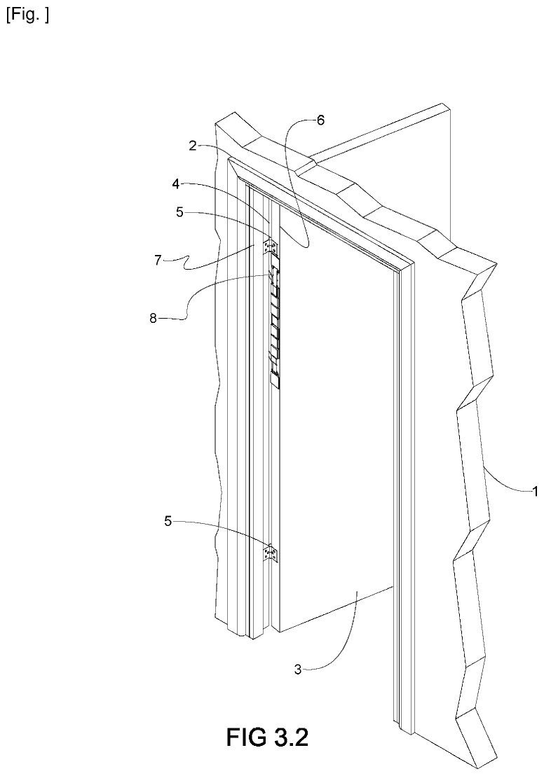

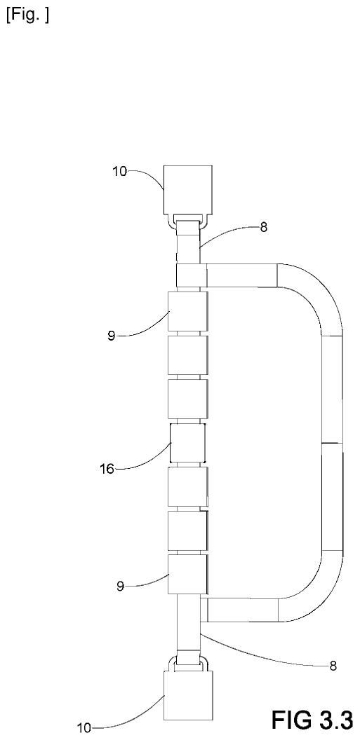

FIGS. 2.1 and 2.2 illustrate a second embodiment of the apparatus which differs from the first embodiment in that a second “U” shaped handle 14 is provided. This is generally similar to the first handle but deployed as a mirror image of the first handle, secured to the uppermost and lowest bumper pads 9 to project from the hinge gap towards the stop side of the door frame.

FIGS. 3.1 to 3.3 depict a fourth embodiment of the apparatus in which the handle 15 is attached directly to the flexible elastic strip 8 at a point above and below the uppermost and lowermost of the seven bumper pads 9. The handle 15 is provided with an asymmetric cross section such that the height of the section is much greater than the thickness. The handle and elastic strip may be formed by moulding from a thermoplastic elastomer (TPE). In a variant of the third embodiment (not shown) a second handle may be provided in a mirror image position to the first handle.

In addition to the six resiliently deformable foam pads 9 one rigid pad 16 is provided on the strip 8. The rigid pad 16 is of a thickness significantly less than the resiliently deformable pads 9.

1-15. (canceled)

16. Apparatus to minimise injury caused by an extremity trapped between a closing door leaf having a hinge stile and mounted by means of a hinge acting between the hinge stile and a hinge jamb member of a door frame adjacent a door stop comprising:
a flexible member capable of attachment to the hinge jamb or hinge stile, said flexible member supporting a bumper, whereby the bumper is urged to a first condition settled into a hinge space between the hinge stile and the hinge jamb when the door is swung on its hinges to an at least partially open condition, said bumper acting to resist the door closing fully, and
a handle arranged to be manually operable to move the bumper from the first condition to a second condition when the door is opened, where the bumper is displaced from the hinge space to facilitate full closure of the door;
said handle being fabricated to be resiliently deformable in a first horizontal direction and substantially rigid in a second direction corresponding to a vertical direction when installed on a hinge stile or hinge jamb, whereby the handle can project through a hinge gap to be accessed from the hinge side of the door, said bumper being resiliently deformable to facilitate drawing the bumper through the hinge gap by means of the handle.

17. The apparatus according to claim 1, wherein the flexible member is elastic and adapted to be attached to the hinge stile or the hinge jamb above and below the bumper, under tension, whereby the flexible member provides a spring force, when displaced to the second condition, to urge the bumper to the first condition.

18. The apparatus according to claim 1, wherein the flexible member is attachable by at least two adhesive pads disposed above and below the bumper to the hinge stile or hinge jamb.

19. The apparatus according to claim 1, wherein the bumper is provided by one or more resiliently deformable cushions.

20. The apparatus according to claim 1, wherein the thickness of the resiliently deformable cushion is greater than the thickness of the door leaf to engage the door stop when in the first condition.

21. The apparatus according to claim 1, wherein a bumper is provided by a rigid cushion in addition to a resiliently deformable cushion.

22. The apparatus according to claim 1, wherein the width of the rigid cushion is less than the each resiliently deformable cushion.

23. The apparatus according to claim 1, wherein the cushion is wedge shaped.

24. The apparatus according to claim 1, wherein the base of the wedge faces the handle intended to project through the hinge gap.

25. The apparatus according to claim 1, according to any one of the preceding claims wherein the handle is attached to one or more of the bumpers or the flexible member.

26. The apparatus according to claim 1, according to claim 10 wherein the handle is attached at two vertically spaced locations either, respectively above and below the uppermost and lowest bumper or to the uppermost and lowest bumper, to span and therefore to displace all the bumpers substantially equally.

27. The apparatus according to claim 1, wherein a second handle projects oppositely to the first handle so that the second handle will project from the hinge gap.

28. The apparatus according to claim 1, wherein the second handle is resiliently deformable to conform to the space between the door stop and the door leaf when the door leaf is closed and to recover when the door leaf is opened.

29. The apparatus according to claim 1, wherein the handle is shaped from resilient wire and supports a grip part.

30. The apparatus according to claim 1, wherein the handle and the flexible member are moulded unitarily from thermoplastic elastomer.
